(19) United States
(12) Patent Application Publication
(10) Pub. No.: US 2006/0043751 A1
(43) Pub. Date: Mar. 2, 2006

(54) Rearview mirror and sun visor assembly

(76) Inventor: Milton Thomas Mellon, Simpsonville, SC (US)

Correspondence Address: MILTON THOMAS MELLON, 2416 ROPER MOUNTAIN RD., SIMPSONVILLE, SC, 29681, US

(21) Appl. No.: 11/212,200

(22) Filed: Aug. 26, 2005

Related U.S. Application Data
(60) Provisional application No. 60/605,435, filed on Aug. 30, 2004.

(51) Int. Cl. B62C 1/00

(52) U.S. Cl. 296/1.11

(57) ABSTRACT

This invention is an improvement in the state of the art by reconfiguration of existing rear view mirrors and sun visors. This invention achieves this by increasing the current minimum required rearward field of view that is about 36 degrees to a field of view that is about 80 degrees; it increases view of the left and right adjacent lanes—the traditional blindspots. This invention is a three-mirror-two-visor assembly that mounts inside the occupant compartment, between the A pillars, at the top of the windshield, but under the windshield top frame. The assembly is supported by fastening to the windshield frame and/or by adhesion to the windshield. The left mirror provides a field of view out the left side, the right mirror provides a field of view out the right side, and the center mirror provides a rear view from the left to the right side of the vehicle. Located in front of the center mirror are two sun visors that manually slide horizontally to a retainer in front of the left mirror and the right mirror. This invention applies to vehicles in which the driver has 360 degrees of reasonably unobstructed horizontal view; it does not apply to long vehicles such as buses and vehicles that tow trailers.

### CROSS-REFERENCE TO RELATED APPLICATION

This application claims the benefit of prior filed provisional application for patent titled REARVIEW MIRROR AND SUN VISOR ASSEMBLY, application No. 60/605,435, filing date of Aug. 30, 2004, filed by Milton Thomas Mellon, a citizen of the United States of America who resides at 2416 Roper Mountain Road, Simpsonville, S.C. 29681.

### SPONSORED RESEARCH

Not Applicable.

### REFERENCE TO AN APPENDIX

Not Applicable.

### BACKGROUND OF THE INVENTION

Rearview mirrors, as defined in 49CFR571.111, are required in motor vehicles by the National Highway Traffic Safety Administration (NHTSA), Department of Transportation. The purpose of rearview mirrors is to reduce the number of deaths and injuries that occur when the driver of a motor vehicle does not have a clear and reasonably unobstructed view to the rear. Current state of the art, as regulated by NHTSA, could be more effective in achieving this goal.

Problems with the current inside rearview mirror are (1) the field of view in most vehicles is close to the required minimum horizontal included angle of about 20 degrees, but this usually limits the view out the rear window between the C pillars; (2) the inside rearview mirror is usually large enough to obstruct forward vision; the smaller the windshield, the greater the obstruction to forward vision; and (3) the inside rearview mirror is usually positioned low enough to allow sunlight or overhead streetlight to occasionally enter the occupant compartment between mirror and windshield top frame and interfere with driver vision.

Problems with the current outside rearview mirror, driver's side, are (1) the driver's side field of view to the rear in most vehicles is close to the required minimum horizontal included angle of about 13 degrees, but this allows a blind spot in the adjacent left lane between the reflected field of view and the driver's peripheral vision; (2) visibility under all but ideal conditions is impaired by road grime, rain, snow, or ice on the outside surface of the driver's window and on the mirror surface; (3) there is usually no prismatic day-night adjustment feature to prevent momentary blinding of the driver by high beams from the rear; (4) the required vertical and horizontal adjustment feature is usually executed by an expensive—relative to manual—electrical system; (5) some mirrors have an expensive heating system; (6) the mirror contributes to air turbulence noise in the occupant compartment; (7) the mirror contributes to air turbulence in the occupant compartment when the driver side windows are open during vehicle motion; (8) the outside mirror creates drag on the vehicle and increases fuel consumption, consequently, increases operating cost; and (9) the projection of the mirror from the side of the vehicle is a potential impact threat to pedestrians and property.

Problems with the current outside rearview mirror, passenger's side, are (1) the driver's field of view to the right-side rear in most vehicles is close to the required minimum horizontal included angle of about 13 degrees, but this allows a blind spot in the adjacent right lane between the reflected field of view and the driver's peripheral vision; (2) visibility under all but ideal conditions is impaired by road grime, rain, snow, or ice on the outside surface of the passenger's window and on the mirror surface; (3) there is usually no prismatic day-night adjustment feature to prevent momentary blinding of the driver by high beams from the rear; (4) the required vertical and horizontal adjustment feature is usually executed by an expensive—relative to manual—electrical system; (5) some mirrors have an expensive heating system; (6) the mirror contributes to air turbulence noise in the occupant compartment; (7) the mirror contributes to air turbulence in the occupant compartment when the passenger side windows are open during vehicle motion; (8) the outside mirror creates drag on the vehicle and increases fuel consumption, consequently, increases operating cost; (9) the projection of the mirror from the side of the vehicle is a potential impact threat to pedestrians and property; and (10) the convex mirror that is permitted by NHTSA regulation and included on some vehicles provides an inaccurate perception to the driver on the proximity of objects to the right and rear of the vehicle.

Problems with current sun visors are (1) they protrude into the driver's forward view when rotated up or down; (2) they occasionally loosen and drop into the driver's forward view; and (3) they often do not provide complete coverage of the upper windshield, for example, between the inside rearview mirror and the windshield top frame.

### BRIEF SUMMARY OF THE INVENTION

This invention is an improvement in the state of the art that address the above problems by reconfiguration of existing rear view mirrors and sun visors, consequently; reduce vehicle occupant and pedestrian deaths and injuries; reduce vehicle and property damage; reduce complexity and number of components necessary to manufacture current mirror and visor systems and therefore lower vehicle initial cost and maintenance costs; and decrease vehicle fuel consumption. This invention achieves this by increasing the current minimum required rearward field of view that is about 36 degrees to a field of view that is about 80 degrees; it increases view of the left and right adjacent lanes which is far more relevant to safety than what is happening back at the horizon.

This invention applies to vehicles in which the driver has 360 degrees of reasonably unobstructed horizontal view; it does not apply to long vehicles such as buses and vehicles that tow trailers. Long vehicles such as buses and vehicles that tow trailers need the supplemental outside mirrors because the vehicle itself or trailer obscure rear vision.

This invention is a three-mirror-two-visor assembly that mounts inside the occupant compartment, between the A pillars, at the top of the windshield, but under the windshield top frame. The assembly is supported by fastening to the windshield frame and/or by adhesion to the windshield. The left mirror provides a field of view out the left side, the right mirror provides a field of view out the right side, and the center mirror provides a rear view from the left to the right side of the vehicle. Located in front of the center mirror are two sun visors that manually slide horizontally to a retainer in front of the left mirror and the right mirror.

### BRIEF DESCRIPTION OF THE SEVERAL VIEWS OF THE DRAWING

A brief description of the drawing views follows:

TABLE 1: Legend for FIG. 1 and FIG. 2.

FIG. 1: Driver's View of Windshield and Rearview Mirror and Sun Visor Assembly.

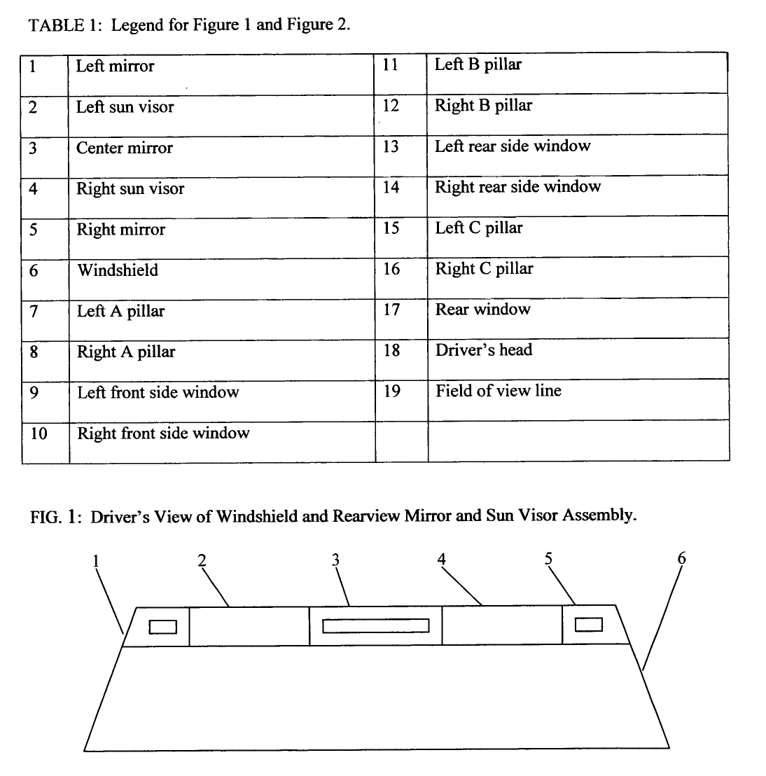

FIG. 2: Plan View of Typical Passenger Vehicle Transparent Glazing, Mirrors, Driver's Head, and Field of View.

### DETAILED DESCRIPTION OF THE INVENTION

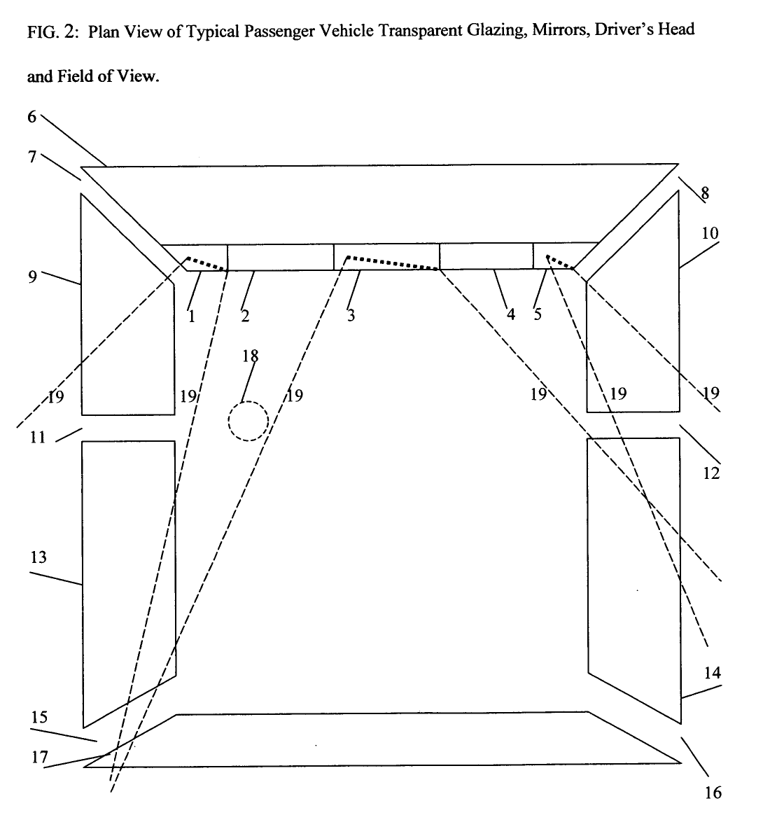

This invention is a three-mirror-two-visor assembly that mounts inside the occupant compartment, between the left A pillar, 7, and right A pillar, 8, at the top of the windshield, 6, but under the windshield top frame. A functional configuration of the three-mirror-two-visor assembly is vehicle make and model specific but each mirror would employ unit magnification, a pivot point for each mirror to allow vertical and horizontal tilt adjustment, and probably prismatic day-night adjustment. Approximate field of view lines, 19, for each mirror are shown in FIG. 2. Rear field of view provided by the assembly is approximately 80 degrees in vehicles that the driver has 360 degrees of reasonably unobstructed horizontal view. The assembly eliminates the need for outside mirrors, consequently, aerodynamic drag will decrease and fuel mileage will increase for a given vehicle.

The left mirror, 1, provides a field of view out the left side of the vehicle from behind the left A pillar, 7, through the left front side window, 9, past the left B pillar, 11, through the left rear side window, 13, to the left C pillar, 15. The left mirror reflective surface can be smaller than the current outside mirror because it is closer to the eyes of the driver, 18, and must be narrow enough not to obscure the driver's forward vision at signal lights. Combined, the left mirror, 1, and center mirror, 3, eliminate the need for driver's to look backward over their left shoulder before changing to the left lane.

The center mirror, 3, provides a field of view from the left C pillar, 15, through the rear window, 17, past the right C pillar, 16, through the right rear side window, 14, to the right B pillar, 12. The center mirror reflective surface must be wider than the current center mirror in order to provide the above stated field of view and should be about one-third the width between the left and right mirrors in order to hide the sun visors when not in use.

The right mirror, 5, provides a field of view out the right side of the vehicle past the right B pillar, 12, through the right front side window, 10, to behind the right A pillar, 8. The right mirror reflective surface can be smaller than the current outside mirror because it is closer to the driver's eyes and should be narrow enough not to obscure the passenger's forward vision. Combined, the right and center mirror eliminate the need for driver's to look backward over their right shoulder before changing to the right lane.

Located in front of the center mirror, 3, are the left sun visor, 2, and right sun visor, 4, that manually slide horizontally to a retainer in front of the left mirror and right mirror, respectively. The retainer is a slot that the visor slides into to help prevent vibration. Each visor has a handle for manual operation, is constrained in a low friction guide at it's top, and is constructed of thin, resilient, opaque material with a low coefficient of friction.

With respect to the above description, it is to be realized that the optimum relationships for the parts of the invention in regard to size, location, shape, form, materials, function and manner of operation, assembly and use are deemed readily apparent and obvious to those skilled in the art, and all equivalent relationships to those illustrated in the drawing and described in the specification are intended to be encompassed by the present invention. The present invention is capable of other embodiments and of being practiced and carried out in various ways.

It is to be understood that the phraseology and terminology employed herein are for the purpose of description and should not be regarded as limiting. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

1. The driver'side inside rearview mirror, located along the A pillar, provides enhanced visibility that includes the traditional blind spot in the adjacent left lane between the reflected field of view and the driver's peripheral vision.

2. The passengers's side inside rearview mirror, located along the A pillar, provides enhanced visibility that includes the traditional blind spot in the adjacent right lane between the reflected field of view and the driver's peripheral vision.

3. The centrally located inside rearview mirror has a wider, lower height glazing that provides rear visibility between the driver's and passenger's side rearview mirrors and provides a mounting location for side-sliding sunvisors.
